(19) United States
(12) Patent Application Publication
(10) Pub. No.: US 2026/0186996 A1
(43) Pub. Date: Jul. 2, 2026

(54) DEVICES, SYSTEMS, AND METHODS TO OPTIMIZE POWER MANAGEMENT WITHIN IN DIE-TO-DIE INTERCONNECTS

(71) Applicant: Xilinx, Inc., San Jose, CA (US)

(72) Inventors: Prakhar Srivastava, Hyderabad (IN); Sachin Chothani, Hyderabad (IN)

(73) Assignee: Xilinx, Inc., San Jose, CA (US)

(21) Appl. No.: 19/005,995

(22) Filed: Dec. 30, 2024

(51) Int. Cl. G06F 13/36

(52) U.S. Cl. CPC G06F 13/36; G06F 2213/40

(57) ABSTRACT

Devices, systems, and methods manage activity in die-to-die links. A link controller places a die-to-die link in a partially active state, with some lane groups active and others idle, adapting to changing conditions without full link retraining. Lane groups can independently enter an electrical idle state, reducing power consumption without interrupting data transmission over active lanes. Idle lanes can be retrained and reactivated without affecting active lanes. Control messages, may manage lane group states, ensuring synchronized transitions between active and idle states. This approach optimizes power management and maintains data transmission efficiency in die-to-die interconnects.

### BACKGROUND

Communication protocols designed to facilitate interaction between processor dies within a package often include connections for data transmission and control signals. These connections typically consist of multiple channels, which can be grouped for efficient data transfer.

Current specifications present several challenges in power management and efficiency. When multiple protocol stacks are multiplexed over the same physical connection, the bandwidth is divided for each protocol stack, and idle signals are inserted when there is no traffic from a particular protocol stack. This increases power consumption and reduces efficiency. Additionally, existing protocols lack a mechanism to support dynamic data rate changes, requiring the entire connection to undergo retraining, which results in significant latency and power consumption. Furthermore, error handling in standard packages necessitates complete retraining, causing throughput losses and increased power consumption.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an illustrative link between two processor dies.

FIG. 2 is a flow diagram of an illustrative method for operating a die-to-die link.

FIG. 3A is a block diagram of an illustrative link between two processor dies in which all lane groups are active.

FIG. 3B is a block diagram of an illustrative link between two processor dies in which one lane group is in an idle state.

FIG. 4 is a block diagram of an illustrative configuration of a link between two processor dies, in which transmission of data is multiplexed to accommodate data from two or more data sources.

FIG. 5 is a block diagram of an illustrative space-multiplexed configuration of a link between two processor dies.

FIG. 6 is a block diagram of an illustrative multiplexed configuration of a link between two processor dies in which a data source is idle.

FIG. 7 is a block diagram of an illustrative space-multiplexed configuration of a link between two processor dies in which a data source is idle.

FIG. 8 is a block diagram of an illustrative processor package incorporating multiple processor dies.

FIG. 9 is a flow diagram of an illustrative control method for operating a die-to-die link.

FIG. 10 is a flow diagram of an additional illustrative control method for operating a die-to-die link.

FIG. 11 illustrates a system-level die-to-die communication architecture.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION

The systems and methods described herein can be used to manage activity in die-to-die links. In some examples, a link controller can place a die-to-die link in a partially active state, such as with some lane groups active while other lane groups are idle, thereby adapting the die-to-die link to changing conditions without sending the entire link through costly link retraining procedures. Instead, lane groups of a link can be independently set to an electrical idle state, reducing the overall power consumption of the link without interrupting data transmission over the remaining active lanes. Additionally, idle lanes can be retrained and brought back into an active state without retraining active lanes, again preserving data transmission and avoiding periods of zero link bandwidth.

An interconnect may include or refer to a comprehensive system of connections and pathways that facilitate communication between different components within a device or between devices. This system may include physical connections (such as wires, traces, and connectors), communication protocols, control circuits, and any additional infrastructure required to support data transmission. An interconnect ensures that data can flow seamlessly between various parts of a computing system, enabling coordinated operation and data exchange. In the context of die-to-die communication, an interconnect encompasses all the elements that enable data transfer between processor dies within a package.

A link may include or refer to a specific subset of an interconnect that consists of a collection of lanes working together to form a complete communication pathway between two points, such as between two processor dies. A link can be unidirectional or bidirectional, allowing data to be transmitted in one or both directions. A link ensures efficient and reliable data transmission by utilizing multiple lanes to increase the overall data transfer capacity. In some configurations, a link may include multiple lane groups, each of which can be independently controlled and managed to optimize performance and power consumption.

A lane may include or refer to a single data transmission pathway within an interconnect system. A lane may include both the physical medium (such as a wire or trace on a circuit board) and the associated circuitry on the dies that handle the transmission and reception of data signals. Each lane may operate independently, carrying data from one point to another. Multiple lanes can be grouped together within a link to enhance the overall data transfer rate and provide redundancy. In the context of die-to-die communication, lanes are the fundamental building blocks that enable data to be transmitted between processor dies.

Some computing architecture uses non-monolithic configurations of components, some of which may feature interconnects between different dies of a larger package. These interconnects can be used by die-to-die links to carry data between the different components of the larger package. Such links can operate according to a variety of protocols. One such protocol is Universal Chiplet Interconnect Express (UCIe), which addresses some of the particular challenges of communication via die-to-die links. These protocols typically include procedures for initializing and training the die-to-die links to facilitate communication between pairs of dies, including operations for link reversal, altering lane usage (e.g., in response to detecting errors and/or lane failures), and/or modifying link bandwidth (e.g., to reduce power consumption in exchange for fewer transfers per second).

Existing standards for communication via die-to-die links may suffer from a number of problems. For example, when link parameters are to be changed during a link's operation, traditional methods dictate that the entire link be retrained, rendering the link temporarily unavailable for data transfer such that the link has a bandwidth of zero for the duration of the retraining. Parameters that may change include the activation status of lane groups (e.g., active or idle), the link bandwidth (e.g., data transfer rate), a number of data sources attempting to transmit data over the link, etc. Furthermore, link retraining can be costly in terms of power consumption and heat generation due to the number of signals that are sent from one die to another during the retraining process.

With some protocols, communications from two or more sources (e.g., protocol stacks) can be time-multiplexed and transmitted over a shared set of interconnects of a die-to-die link. Time-multiplexed link sharing, which generally involves the sources transmitting messages over the shared interconnects in an alternating sequence of time periods, can present additional challenges. For example, when one of the sources has no data to transmit, time-multiplexed link sharing protocols may require the inactive source to transmit placeholder messages or flits to guarantee temporal ordering of messages from the different sources, thereby simplifying the design of the receiver. Such placeholder messages contain no meaningful data but still consume electrical power and link bandwidth, essentially becoming “wasted” transmissions.

The inventors have appreciated that configuring a link controller to control parameters of each lane groups independently of parameters of other lane groups can provide solutions to the above-described problems. In some examples, the link controller can independently place one or more lane groups into an electrical idle state and/or independently retrain one or more lane groups without disrupting data transmission over the link's other lane groups, thereby enabling transmission of data over the lanes of the link's active lane groups while simultaneously reconfiguring other lane groups and avoiding unnecessary retraining of lanes already operating with the desired parameters. Avoiding unnecessary retraining and continuing to transmit data via active lanes while other lanes are being reconfigured (e.g., placed into the electrical idle state and/or retrained) can greatly enhance the link's utilization and data transfer rate, while also improving the link's power efficiency (e.g., milliwatts/megabyte of transmitted data). In some examples, lane groups can be reconfigured in response to a variety of situations, including detecting errors or faults in one lane group and/or changes in bandwidth requirements of the sources.

In some examples, by controlling the parameters of a link's lane groups independently, the link controller can provide space-multiplexed sharing of the link's interconnects among two or more sources, rather than time-multiplexed sharing. In a space-multiplexed configuration, each participating source (e.g., protocol stack) can transmit data via a different lane group of the die-to-die link. When a source does not have data to send via the link (e.g., the lane group allocated to that source is expected to remain idle for longer than a predetermined period of time), the link controller can place the corresponding lane group in the electrical idle state, thereby lowering the overall power consumption and heat generation of the link while preserving transmission of data over the remaining lanes. Moreover, the link controller can idle the lane group without retraining the entire link, thereby avoiding situations in which the link bandwidth is effectively zero for a period of time. Should link bandwidth demands increase, such as when a previously idle source becomes active again, the link controller can retrain idle lane groups and bring them back into an active state independently of other lane groups, once again avoiding interruptions in the data transmission over other lane groups.

Configuring the parameters of lane groups independently can provide a number of benefits. For example, the link controller can degrade (e.g., reduce) link width quickly without retraining the active lane groups, avoiding interruptions of active data lanes and reducing overall power consumption and/or heat generation of the interconnect. Additionally, the link controller can retain idle lanes without interrupting the functionality of active lanes. Moreover, in situations where communications from multiple sources are multiplexed via the link, the operating parameters of different lane groups can be changed independently to adapt to changes in transmission requirements, without using wasteful placeholder messages.

In some examples, one or more components of one or more embodiments of the present disclosure (e.g., a link controller) may implement or use a new power management state referred to as “Active Partial” or “ACTIVEp”. The ACTIVEp state may allow for more granular control over the power management of lane groups within a die-to-die interconnect link. Specifically, when the link is in the ACTIVEp state, different groups of lanes can be independently retrained and placed into an electrical idle state. This means that one group of lanes can be put into a low-power mode while another group continues to carry data traffic. The ACTIVEp state may help to optimize power consumption by allowing parts of the link to be idle when they are not needed, without requiring a complete retraining of the entire link.

To manage the transition of lane groups into and out of the ACTIVEp state, some embodiments of the present disclosure may use a combination of a control register and/or control messages referred to as ACTIVEp.reconfigure. Once the control register is modified by a die partner to achieve a new configuration, an ACTIVEp.reconfigure control message is sent to the other die partner. This request initiates the necessary steps on the other partner's side and modifies the control register in the other die partner's configuration space, ensuring synchronized transitions and maintaining data transmission efficiency. These ACTIVEp.reconfigure messages may be exchanged between the dies over the sideband connection and include the following:

ACTIVEp.reconfigure req: This is a request message sent by the UCIe module to initiate a reconfiguration of the lane groups. The message indicates whether a group of lanes should be placed into or brought out of the electrical idle state. For example, if the data transfer requirements decrease, the UCIe module can send an ACTIVEp.reconfigure req message to place a group of lanes into the electrical idle state, thereby conserving power.

ACTIVEp.reconfigure resp: This is a response message sent by the receiving die to acknowledge the reconfiguration request. Before sending the ACTIVEp.reconfigure resp message, the die partner ensures that the transmitter logic and corresponding transmission (TX) lines of the specified group of lanes, which need to be disabled, are set to electrical idle. Upon receiving this message, the other die partner also puts its TX lines to electrical idle. In the case of an upconfigure scenario, where lane groups need to be brought out of electrical idle, the receivers are turned on and activated first, followed by enabling the transmitter logic. This process ensures that the lane groups are correctly transitioned to the desired state.

These control messages ensure that both dies are synchronized in terms of the lane group states, allowing for seamless transitions between active and idle states without disrupting ongoing data transmission. The use of ACTIVEp.reconfigure messages helps to dynamically adjust the link configuration based on real-time data transfer requirements and error conditions, thereby optimizing power management and maintaining data transmission efficiency.

The ACTIVEp state and ACTIVEp.reconfigure messages may provide a mechanism for fine-grained control over the power management of die-to-die interconnect links. By allowing lane groups to be independently placed into and brought out of the electrical idle state, the invention reduces power consumption and improves the overall efficiency and reliability of the interconnect system.

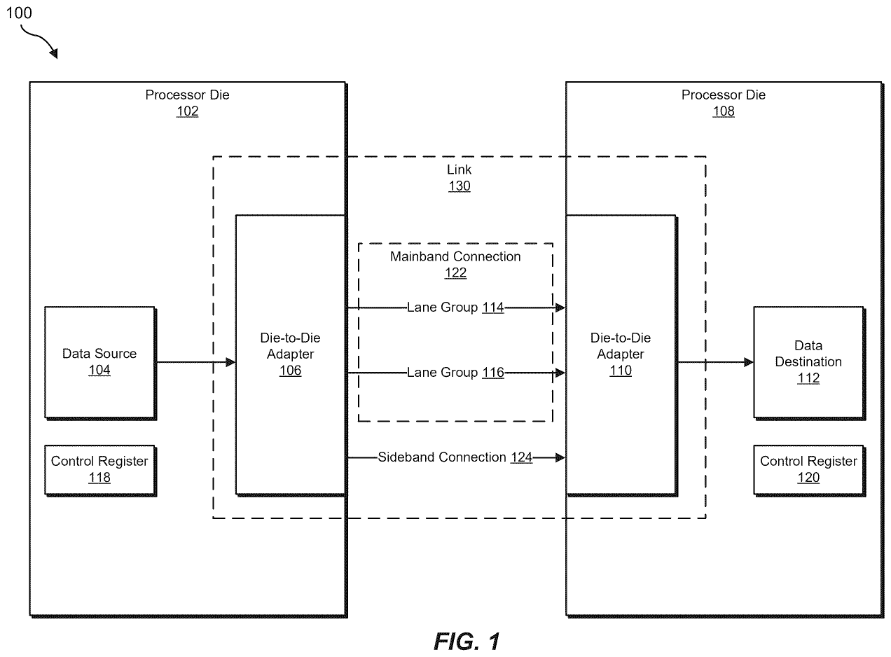

FIG. 1 shows a block diagram of an example system 100 that includes an illustrative link between two processor dies. Processor die 102 includes a data source 104, a die-to-die adapter 106, and a control register 118. Processor die 108 includes a data destination 112, a die-to-die adapter 110, and a control register 120.

Link 130 connects processor die 102 and processor die 108. As shown, link 130 may include a sideband connection 124 and a mainband connection 122. The sideband connection 124 facilitates communication between the die-to-die adapter 106 on processor die 102 and the die-to-die adapter 110 on processor die 108. The mainband connection 122 includes lane group 114 and lane group 116.

The die-to-die link adapters facilitate the transmission and reception of data across the die-to-die link, ensuring efficient and reliable communication between the dies. These adapters are responsible for managing the data flow between the dies and the link, which comprises a mainband connection 122 and a sideband connection 124.

The mainband connection 122 is used for the primary data transmission between the processor dies. It includes multiple lane groups, such as lane group 114 and lane group 116, which can be independently controlled to optimize power management and data transmission efficiency. The die-to-die link adapters handle the data packets (flits) transmitted over these lane groups, ensuring that data is correctly routed and received by the appropriate destination on the other die.

The sideband connection 124 is used for control signals and link state management packets. This connection allows the die-to-die link adapters to communicate and coordinate the state of the link, including the activity states of the lane groups. For example, the sideband connection can be used to transmit control register values and sideband messages, such as ACTIVEp.reconfigure requests and responses, which facilitate the negotiation and confirmation of lane group states between the dies.

The die-to-die link adapters also play a crucial role in detecting status changes of the link, such as errors in the lanes or changes in data transfer requirements. Upon detecting such changes, the adapters can update the control registers (e.g., control registers 118 and/or 120) to modify the activity states of the lane groups, placing them in an electrical idle state or retraining them as needed. This independent control of lane groups allows the system to dynamically adjust to changing conditions without necessitating a complete link retraining, thereby optimizing power management and maintaining data transmission efficiency.

Data source 104 on processor die 102 transmits data to data destination 112 on processor die 108 via the die-to-die adapter 106, mainband connection 122, and die-to-die adapter 110. Control register 118 on processor die 102 and control register 120 on processor die 108 manage the activity states of lane group 114 and lane group 116, enabling independent control of each lane group.

The mainband connection 122 is responsible for carrying the primary data traffic between processor die 102 and processor die 108. Lane group 114 and lane group 116 within the mainband connection 122 can be independently set to an electrical idle state or retrained without affecting the data transmission on the other lane group. This independent control helps optimize power management and maintain data transmission efficiency.

The sideband connection 124 handles control signals and link state management packets between the die-to-die adapters 106 and 110. This connection ensures that the mainband connection 122 can be dynamically reconfigured based on the current data rate requirements and error conditions, without necessitating a complete link retraining.

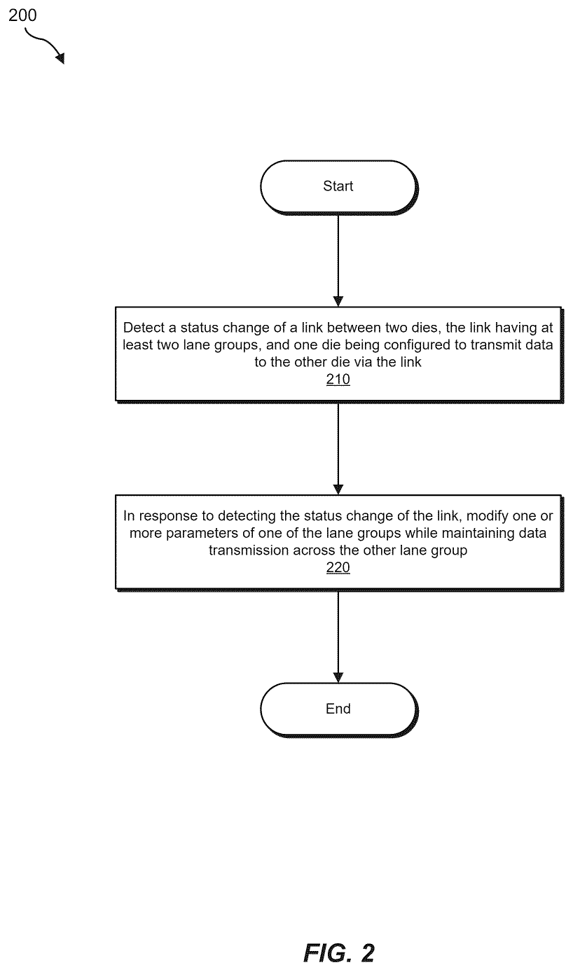

FIG. 2 shows a flow diagram of an example method 200 for operating a die-to-die link. Example method 200 may be implemented by one or more components of one or more of the example systems described herein (e.g., example system 100, example system 300, example system 400, example system 500, example system 600, example system 700, and/or package 800).

Method 200 begins with detecting a status change of a link between two dies, the link having at least two lane groups, and one die being configured to transmit data to the other die via the link. This step involves monitoring the link for any changes in the operational status of the link, which could include changes in data transfer rates, error conditions, or other relevant parameters. The method 200 ensures that the link can adapt to the detected status change without interrupting the ongoing data transmission. The parameters that may be modified include placing the lane group in an electrical idle state, retraining the lane group, or adjusting the data transfer rate of the lane group. By maintaining data transmission across the other lane group, the method 200 avoids periods of zero link bandwidth and enhances the overall efficiency and reliability of the die-to-die link.

Step 210 involves detecting a status change of a link between the first die and a second die, the link comprising at least a first lane group and a second lane group, the first die being configured to transmit data to the second die via the link. This step may be useful for identifying any changes in the link's operational status, such as variations in data transfer rates, error conditions, or other relevant parameters. The detection process may ensure that the link can respond to these changes promptly, maintaining the integrity and efficiency of data transmission between the dies.

Detecting the status change of the link may include detecting one or more errors in one or more lanes of the first lane group, and that modifying the one or more parameters of the first lane group comprises placing the first lane group in an electrical idle state. This process may involve monitoring the link for any errors that may occur in the lanes of the first lane group.

When an error is detected in one or more lanes of the first lane group, the system may respond by updating the control register to reflect the new activity state of the first lane group. Specifically, the control register value may be set to indicate that the first lane group should be placed in an electrical idle state. This action may deactivate the transmission circuitry associated with the first lane group, thereby preventing the transmission of corrupted data and conserving power.

By placing the first lane group in an electrical idle state, the system ensures that data transmission continues uninterrupted across the second lane group. This independent control of lane groups allows the system to dynamically adjust to changing conditions without necessitating a complete link retraining. As a result, the overall efficiency and reliability of the die-to-die link are enhanced, and periods of zero link bandwidth are avoided.

In some examples, the first die may include a first control register (e.g., control register 118 and/or control register 120), which specifies at least an activity state of the first lane group and an activity state of the second lane group. The control register may play a role in managing the states of the lane groups based on the detected status changes.

When a status change is detected, such as a decrease in data transfer requirements or the identification of errors in the lanes of the first lane group, the control register may be updated to reflect the new activity states of the lane groups. For instance, if the first lane group needs to be placed in an electrical idle state, the control register value is set to indicate this change. This ensures that the system can dynamically adjust the activity states of the lane groups in response to real-time conditions, optimizing power management and maintaining data transmission efficiency.

The control register's ability to specify the activity states of the lane groups allows for independent control of each lane group. This means that while the first lane group is placed in an electrical idle state, the second lane group can continue transmitting data without interruption. By leveraging the control register to manage the activity states, the system can avoid the need for complete link retraining, thereby reducing latency and enhancing the overall reliability of the die-to-die link.

In some examples, placing the first lane group in the electrical idle state may include setting a control register value stored in the first control register to a value indicating that the first lane group is in the electrical idle state. When a status change is detected, such as a decrease in data transfer requirements or the identification of errors in the lanes of the first lane group, the control register is updated to reflect the new activity state of the first lane group. This ensures that the system can dynamically adjust the activity states of the lane groups in response to real-time conditions, optimizing power management and maintaining data transmission efficiency.

The operations may include transmitting signals indicating the control register value from the first die to the second die via a sideband communication channel. This ensures that both dies are synchronized in terms of the lane group states. Hence, after detecting a status change and updating the control register, the first die may send a sideband message to the second die to inform it of the new state of the first lane group. This communication ensures that both dies operate in harmony, maintaining the integrity and efficiency of the die-to-die link.

The operations may further include returning the first lane group to an active state while maintaining data transmission across the second lane group. This involves retraining the first lane group. If the status change indicates that the data transfer requirements have increased or the errors have been resolved, the control register may be updated to bring the first lane group back to an active state. The retraining process is initiated to ensure that the first lane group is properly configured for data transmission, all while maintaining uninterrupted data transmission across the second lane group.

In some examples, returning the first lane group to the active state may further include setting the control register value to a value indicating that the first lane group is in the active state. Thus, after detecting that the conditions necessitating the electrical idle state have changed, the control register is updated to reflect the new active state of the first lane group. This ensures that the system can quickly and efficiently transition the first lane group back to an active state, optimizing data transmission and power management.

Returning to FIG. 2, step 220 involves, in response to detecting the status change of the link, modifying one or more parameters of the first lane group while maintaining data transmission across the second lane group. This step ensures that the link can adapt to the detected status change without interrupting the ongoing data transmission. The parameters that may be modified include placing the lane group in an electrical idle state, retraining the lane group, or adjusting the data transfer rate of the lane group. By maintaining data transmission across the other lane group, step 220 avoids periods of zero link bandwidth and enhances the overall efficiency and reliability of the die-to-die link.

In some examples, modifying the one or more parameters of the first lane group may include placing the first lane group in an electrical idle state. This may involve transitioning the first lane group from an active state, where data transmission occurs, to an idle state, where the lanes cease data transmission and enter a low-power mode. The electrical idle state reduces power consumption by deactivating the transmission circuitry associated with the first lane group, thereby conserving energy while maintaining the operational status of the second lane group for ongoing data transmission.

The process of placing the first lane group in an electrical idle state can be initiated in response to various conditions, such as detecting a decrease in data transfer requirements or identifying errors in the lanes of the first lane group. By independently controlling the state of each lane group, the system can dynamically adjust to changing conditions without necessitating a complete link retraining. This approach ensures that data transmission continues uninterrupted across the second lane group, thereby avoiding periods of zero link bandwidth and enhancing the overall efficiency and reliability of the die-to-die link.

The electrical idle state may include a low-power mode where the lanes of the first lane group are deactivated, but the physical connection remains intact. This state allows for a quick transition back to an active state when needed, minimizing latency and ensuring that the link can promptly respond to changes in data transfer requirements. The ability to place lane groups in an electrical idle state independently of each other provides significant power savings and improves the overall power management of the die-to-die link.

In still more examples, detecting the status change of the link may include determining that a data transfer rate from a data source on the first die to the link adapter or from the link adapter via the link satisfies a first data transfer rate criterion. In such examples, modifying the one or more parameters of the first lane group may include placing the first lane group in an electrical idle state. This process may involve monitoring the data transfer rate of the link. When the system determines that the data transfer rate has decreased below a certain threshold amount (the first data transfer rate criterion), it updates the control register to place the first lane group in an electrical idle state. This action reduces power consumption by deactivating the transmission circuitry associated with the first lane group while maintaining data transmission across the second lane group.

After detecting the status change and updating the control register, the system may modify the parameters of the first lane group by placing it in an electrical idle state. This ensures that the system can dynamically adjust to changing conditions without necessitating a complete link retraining, thereby optimizing power management and maintaining data transmission efficiency.

In some examples, the operations may further include (1) determining that the data transfer rate satisfies a second data transfer rate criterion, and (2) modifying the one or more parameters of the first lane group to return the first lane group to an active state. Hence, after detecting that the data transfer rate has increased above a certain threshold (the second data transfer rate criterion), the system may update the control register to bring the first lane group back to an active state. This may involve retraining the first lane group to ensure it is properly configured for data transmission.

The system may modify the parameters of the first lane group by returning it to an active state while maintaining data transmission across the second lane group. This ensures that the system can dynamically adjust to increased data transfer requirements, optimizing both power management and data transmission efficiency. This approach may ensure efficient power management and may maintain data transmission efficiency by dynamically adjusting the activity states of the lane groups based on real-time data transfer requirements.

In some examples, detecting the status change of the link may include detecting the cessation of data transmission via the first lane group. Furthermore, modifying the one or more parameters of the first lane group may include placing the first lane group in an electrical idle state. This process may involve monitoring the data transmission activity of a first lane group (e.g., first lane group 114) within the mainband connection (e.g., mainband connection 122). For example, when the system detects that data transmission from the data source 104 on processor die 102 via the first lane group 114 has ceased, it updates the control register 118 to reflect this change in activity.

After detecting the cessation of data transmission, the system may modify the parameters of the first lane group by placing it in an electrical idle state. This action reduces power consumption by deactivating the transmission circuitry associated with the first lane group while maintaining data transmission across the second lane group (e.g., second lane group 116). The die-to-die adapters (e.g., die-to-die adapter 106 on processor die 102 and the die-to-die adapter 110 on processor die 108) coordinate this transition via the sideband connection (e.g., sideband connection 124), ensuring that the link 130 remains operational and efficient.

In some examples, maintaining data transmission across the second lane group may include maintaining data transmission across the second lane group in accordance with the UCIe protocol. This may involve ensuring that the second lane group 116 continues to transmit data from the data source 104 on processor die 102 to the data destination 112 on processor die 108, even as the first lane group 114 is placed in an electrical idle state.

In the context of step 220, the system modifies the parameters of the first lane group 114 by placing it in an electrical idle state while maintaining data transmission across the second lane group 116 in accordance with the UCIe protocol. This ensures that the link 130 remains compliant with the UCIe protocol standards, providing reliable and efficient data transmission. The control registers 118 and 120 on processor dies 102 and 108, respectively, manage the activity states of the lane groups, allowing for seamless transitions and optimal power management.

This approach ensures efficient power management and maintains data transmission efficiency by dynamically adjusting the activity states of the lane groups based on real-time data transmission requirements.

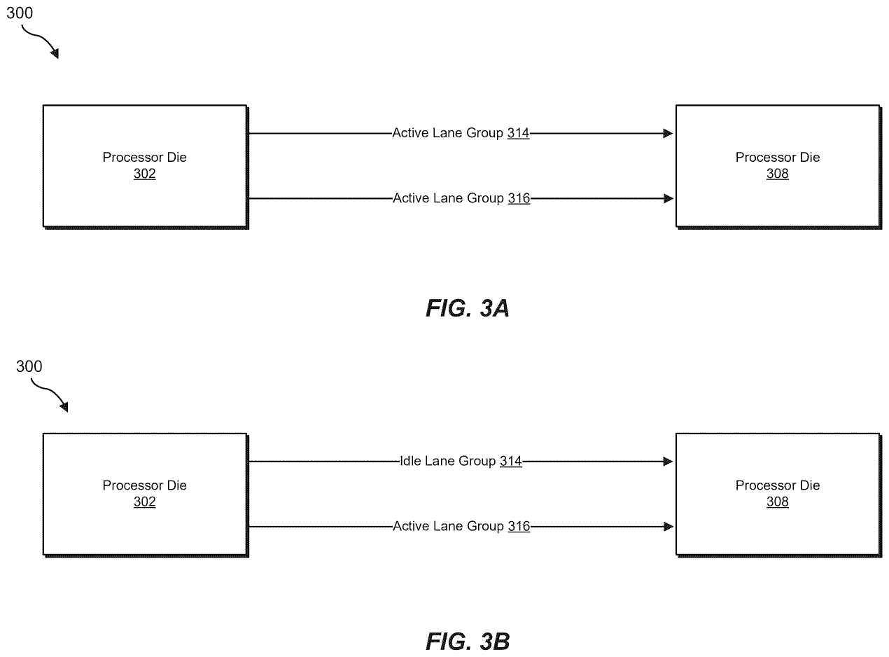

FIG. 3A and FIG. 3B shows an example system 300 that illustrates a link between two processor dies, specifically processor die 302 and processor die 308. Processor die 302 serves as one endpoint of the link and includes the necessary circuitry to transmit and receive data via the active lane groups. Processor die 302 interacts with active lane group 314 and active lane group 316 to manage data flow and ensure that the link operates according to the specified protocol. The processor die may include control logic to dynamically adjust the state of the lane groups based on current data transfer requirements and error conditions.

Active lane group 314 is a collection of lanes within the mainband connection that are currently active and transmitting data between processor die 302 and processor die 308. This lane group can be independently controlled, allowing active lane group 314 to be placed in an electrical idle state or retrained without affecting the operation of other lane groups. The ability to manage active lane group 314 independently helps optimize power consumption and maintain data transmission efficiency.

Active lane group 316 operates similarly to active lane group 314, providing an additional set of lanes for data transmission between processor die 302 and processor die 308. This lane group can also be independently controlled, enabling dynamic adjustments to the state of active lane group 316 based on data transfer needs and error conditions. The independent control of active lane group 316 further enhances the link's power management capabilities and ensures continuous data transmission.

Processor die 308 serves as the other endpoint of the link, receiving data transmitted from processor die 302 via active lane group 314 and active lane group 316. Processor die 308 includes the necessary circuitry to handle incoming data and may also include control logic to manage the state of the lane groups. This processor die works in conjunction with Processor die 302 to maintain efficient and reliable data communication across the link.

FIG. 3B shows a link between two processor dies, specifically processor die 302 and processor die 308, in which one lane group is in an idle state. Processor die 302 serves as one endpoint of the link and includes the necessary circuitry to transmit and receive data via the lane groups. Processor die 302 interacts with idle lane group 314 and active lane group 316 to manage data flow and ensure that the link operates according to the specified protocol. The processor die may include control logic to dynamically adjust the state of the lane groups based on current data transfer requirements and error conditions.

Idle lane group 314 is a collection of lanes within the mainband connection that are currently in an idle state and not transmitting data between processor die 302 and processor die 308. This lane group can be independently controlled, allowing idle lane group 314 to be placed in an electrical idle state or retrained without affecting the operation of other lane groups. The ability to manage idle lane group 314 independently helps optimize power consumption and maintain data transmission efficiency.

Active lane group 316 operates similarly to active lane group 314 in FIG. 3A, providing an additional set of lanes for data transmission between processor die 302 and processor die 308. This lane group can also be independently controlled, enabling dynamic adjustments to the state of active lane group 316 based on data transfer needs and error conditions. The independent control of active lane group 316 further enhances the link's power management capabilities and ensures continuous data transmission.

Processor die 308 serves as the other endpoint of the link, receiving data transmitted from processor die 302 via idle lane group 314 and active lane group 316. Processor die 308 includes the necessary circuitry to handle incoming data and may also include control logic to manage the state of the lane groups. This processor die works in conjunction with processor die 302 to maintain efficient and reliable data communication across the link.

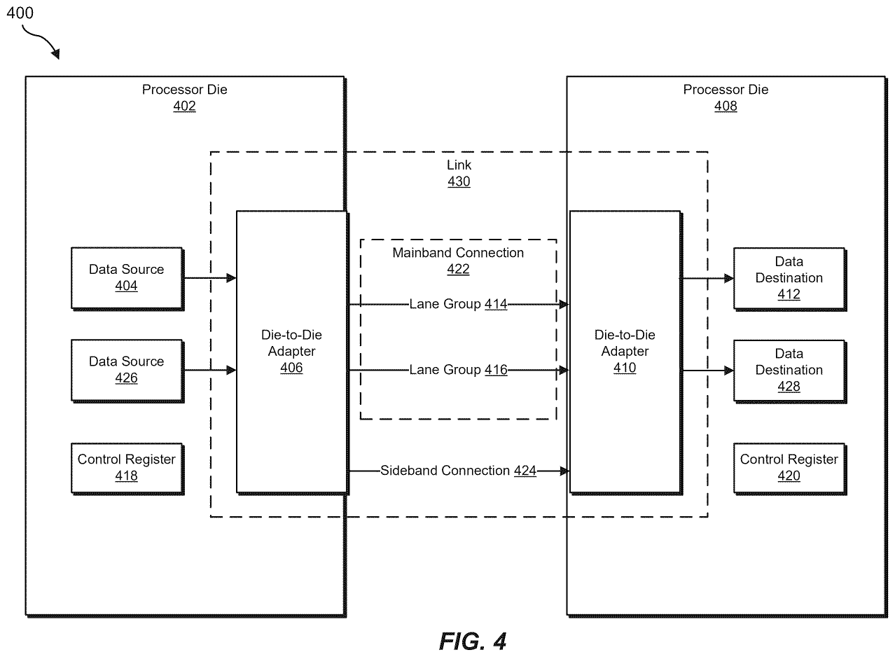

FIG. 4 shows a block diagram of an example system 400 that shows an illustrative configuration of a link between two processor dies, in which transmission of data is multiplexed to accommodate data from two or more data sources.

A processor die 402 includes a data source 404, a data source 426, a die-to-die adapter 406, and a control register 418. The processor die 408 includes a data destination 412, a data destination 428, a die-to-die adapter 410, and a control register 420.

A link 430 connects the processor die 402 and the processor die 408. The link 430 includes a mainband connection 422 and a sideband connection 424. The mainband connection 422 comprises a lane group 414 and a lane group 416. The sideband connection 424 facilitates communication between the die-to-die adapter 406 on the processor die 402 and the die-to-die adapter 410 on the processor die 408.

The data source 404 and the data source 426 on the processor die 402 transmit data to the data destination 412 and the data destination 428 on the processor die 408 via the die-to-die adapter 406, the mainband connection 422, and the die-to-die adapter 410. The control register 418 on the processor die 402 and the control register 420 on the processor die 408 manage the activity states of the lane group 414 and the lane group 416, enabling independent control of each lane group.

The mainband connection 422 is responsible for carrying the primary data traffic between the processor die 402 and the processor die 408. The lane group 414 and the lane group 416 within the mainband connection 422 can be independently set to an electrical idle state or retrained without affecting the data transmission on the other lane group. This independent control helps optimize power management and maintain data transmission efficiency.

The sideband connection 424 handles control signals and link state management packets between the die-to-die adapters 406 and 410. This connection ensures that the mainband connection 422 can be dynamically reconfigured based on the current data rate requirements and error conditions, without necessitating a complete link retraining.

In some examples, the link adapter may spatially multiplex data transmission via the link. Spatially multiplexing data transmission via the link may include transmitting first data provided by a first data source via the first lane group and transmitting second data provided by a second data source via the second lane group. Hence, one or more embodiments of the instant application may monitor the data transmission from multiple data sources. When the system detects a status change, such as the cessation of data transmission from the first data source, it may identify that the first lane group is no longer needed for active data transmission.

After detecting the status change, the system may modify the parameters of the first lane group by placing it in an electrical idle state. This action reduces power consumption by deactivating the transmission circuitry associated with the first lane group while maintaining data transmission across the second lane group, which continues to transmit data from the second data source. This approach ensures that the system can dynamically adjust to changing conditions without necessitating a complete link retraining, thereby optimizing power management and maintaining data transmission efficiency.

In some examples, detecting the status change of the link may include determining that the first data source has stopped transmitting data to the die-to-die link adapter of the first die. Hence, some embodiments may monitor the activity of the first data source. When the system determines that the first data source has stopped transmitting data, it updates the control register to reflect this change in activity.

The system may modify the parameters of the first lane group by placing it in an electrical idle state. This may ensure that the system can dynamically adjust to the cessation of data transmission from the first data source without interrupting the ongoing data transmission from the second data source via the second lane group. By doing so, the system optimizes power management and maintains data transmission efficiency by independently controlling the activity states of the lane groups based on real-time data transmission requirements.

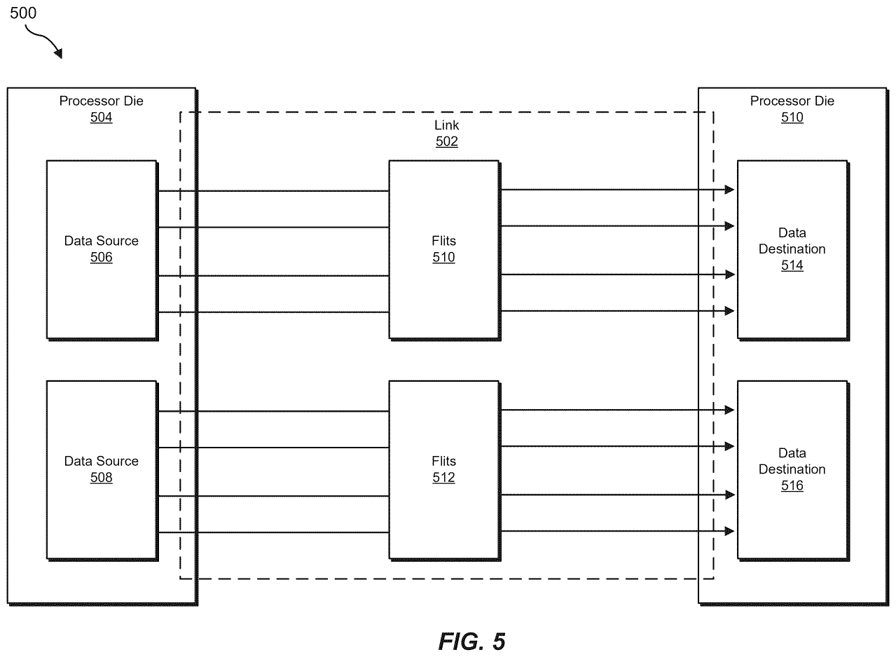

FIG. 5 shows a block diagram of an example system 500 that includes a space-multiplexed configuration of a link between two processor dies. A space-multiplexed configuration of a link between two processor dies may refer to a setup where the data transmission pathways (lanes) of the link are divided into separate groups, each dedicated to transmitting data from different sources simultaneously. This configuration may allow multiple data sources to use the same physical link concurrently by assigning distinct lane groups to each source, thereby optimizing the link's overall data transfer efficiency and reducing the need for time-multiplexed placeholder messages.

As shown in FIG. 5, a link 502 may connect a processor die 504 and a processor die 510. The link 502 may facilitate the transmission of data between the processor die 504 and the processor die 510 using a space-multiplexed configuration.

The processor die 504 may include a data source 506 and a data source 508. The data source 506 and the data source 508 may generate data to be transmitted to the processor die 510. The data from the data source 506 and the data source 508 may be transmitted in the form of flits 510 and flits 512, respectively.

A flit, short for “flow control unit,” is a basic unit of data transmission in network-on-chip (NoC) and interconnect systems. It represents a segment of a larger packet or message that is transmitted across a network or interconnect. Flits are used to manage and control the flow of data, ensuring efficient and orderly transmission between components, such as processor dies, within a system. In the context of the UCIe protocol, flits are used to carry data between protocol layers over a shared physical link, with mechanisms in place to handle the transmission of flits from multiple protocol stacks.

The flits 510 and the flits 512 represent the data packets that are transmitted over the link 502. The flits 510 carry data from the data source 506, while the flits 512 carry data from the data source 508. The link 502 ensures that the data from both data sources is transmitted efficiently to the processor die 510.

The processor die 510 includes a data destination 514 and a data destination 516. The data destination 514 receives the data transmitted as flits 510 from the data source 506. Similarly, the data destination 516 receives the data transmitted as flits 512 from the data source 508. The data destinations 514 and 516 process the received data accordingly.

The space-multiplexed configuration of the link 502 allows the simultaneous transmission of data from multiple data sources to multiple data destinations. This configuration optimizes the use of the link 502 by enabling parallel data transmission paths, thereby enhancing the overall data transfer efficiency between the processor die 504 and the processor die 510.

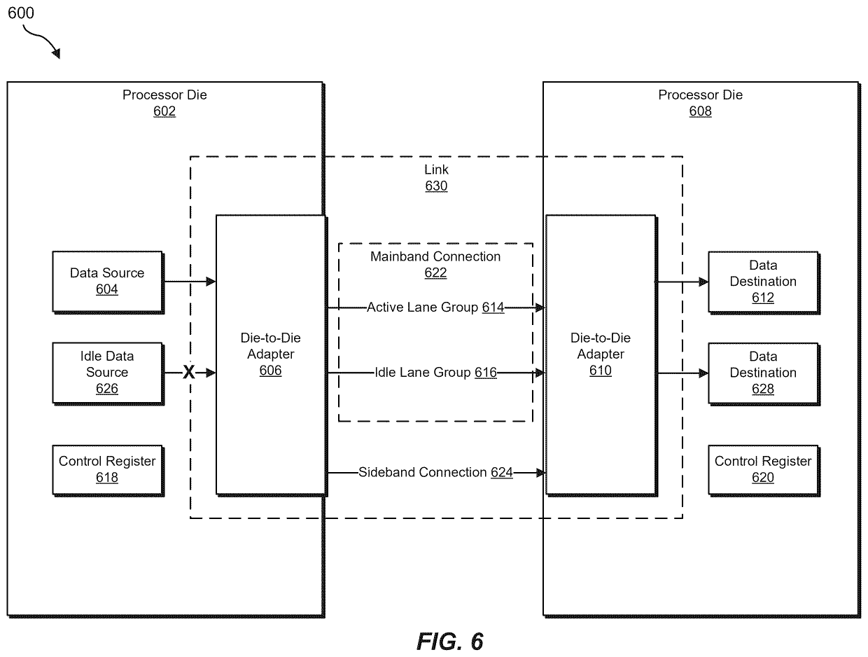

FIG. 6 shows a block diagram of an example system 600 that includes a multiplexed configuration of a link between two processor dies in which a data source is idle. As shown, a processor die 602 includes a data source 604, an idle data source 626, a die-to-die adapter 606, and a control register 618. A processor die 608 includes a data destination 612, a data destination 628, a die-to-die adapter 610, and a control register 620.

A link 630 connects the processor die 602 and the processor die 608. The link 630 includes a mainband connection 622 and a sideband connection 624. The mainband connection 622 comprises an active lane group 614 and an idle lane group 616. The sideband connection 624 facilitates communication between the die-to-die adapter 606 on the processor die 602 and the die-to-die adapter 610 on the processor die 608.

The data source 604 on the processor die 602 transmits data to the data destination 612 on the processor die 608 via the die-to-die adapter 606, the mainband connection 622, and the die-to-die adapter 610. The idle data source 626 on the processor die 602 is currently not transmitting data, and the corresponding lanes in the idle lane group 616 are in an electrical idle state.

The control register 618 on the processor die 602 and the control register 620 on the processor die 608 manage the activity states of the active lane group 614 and the idle lane group 616, enabling independent control of each lane group. This configuration allows the system to optimize power management by placing the idle lane group 616 in an electrical idle state while maintaining data transmission through the active lane group 614.

The mainband connection 622 is responsible for carrying the primary data traffic between the processor die 602 and the processor die 608. The active lane group 614 within the mainband connection 622 is currently active and transmitting data, while the idle lane group 616 is in an electrical idle state, conserving power.

The sideband connection 624 handles control signals and link state management packets between the die-to-die adapters 606 and 610. This connection ensures that the mainband connection 622 can be dynamically reconfigured based on the current data rate requirements and error conditions, without necessitating a complete link retraining.

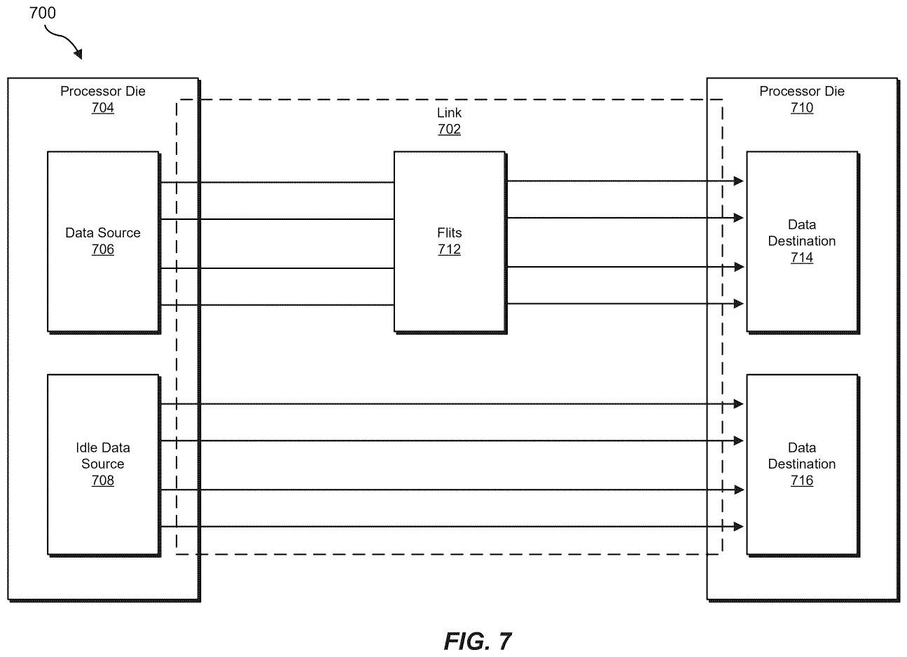

FIG. 7 shows a block diagram of an example system 700 that includes a space-multiplexed configuration of a link between two processor dies in which a data source is idle. As shown, a link 702 connects a processor die 704 and a processor die 710. The link 702 facilitates the transmission of data between the processor die 704 and the processor die 710 using a space-multiplexed configuration.

The processor die 704 includes a data source 706 and an idle data source 708. The data source 706 generates data to be transmitted to the processor die 710. The idle data source 708 is currently not transmitting data, and the corresponding lanes in the link 702 are in an electrical idle state.

The data from the data source 706 is transmitted in the form of flits 712 over the link 702. The processor die 710 includes a data destination 714 and a data destination 716. The data destination 714 receives the data transmitted as flits 712 from the data source 706. The data destination 716 is associated with the idle data source 708 and is currently not receiving data.

The space-multiplexed configuration of the link 702 allows the simultaneous transmission of data from multiple data sources to multiple data destinations. This configuration optimizes the use of the link 702 by enabling parallel data transmission paths, thereby enhancing the overall data transfer efficiency between the processor die 704 and the processor die 710.

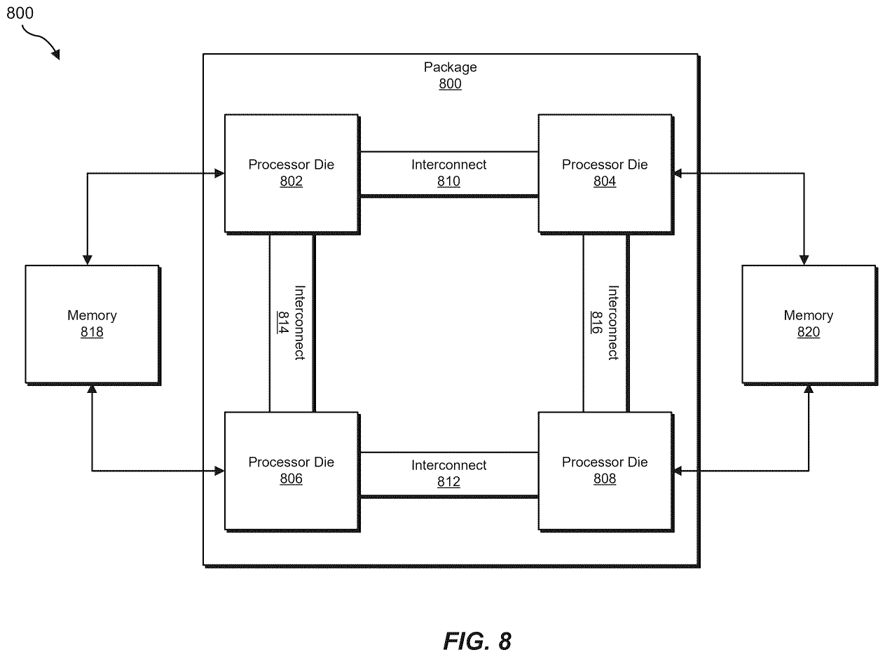

FIG. 8 shows a block diagram of an illustrative processor package incorporating multiple processor dies. Package 800, as shown, includes four processor dies: a processor die 802, a processor die 804, a processor die 806, and a processor die 808. These processor dies are interconnected to facilitate communication and data transfer between them.

An interconnect 810 connects the processor die 802 and the processor die 804. This interconnect enables data transmission and communication between these two processor dies, ensuring efficient data flow within the package 800.

An interconnect 812 connects the processor die 806 and the processor die 808. This interconnect provides a communication pathway between these processor dies, allowing for coordinated operation and data exchange.

An interconnect 814 connects the processor die 802 and the processor die 806. This interconnect facilitates data transfer between these processor dies, enhancing the overall performance and functionality of the package 800.

An interconnect 816 connects the processor die 804 and the processor die 808. This interconnect ensures seamless communication between these processor dies, contributing to the efficient operation of the package 800.

A memory unit 818 is connected to the processor die 802 and the processor die 806. This memory provides storage and retrieval capabilities for data processed by these processor dies, supporting their computational tasks and enhancing their performance.

A memory unit 820 is connected to the processor die 804 and the processor die 808. This memory serves as a storage medium for data processed by these processor dies, enabling efficient data management and retrieval.

The configuration depicted in FIG. 8 illustrates a processor package 800 that incorporates multiple processor dies interconnected by various interconnects. This setup allows for efficient data transfer and communication between the processor dies, supported by memory units 818 and 820, which provide additional storage and data management capabilities.

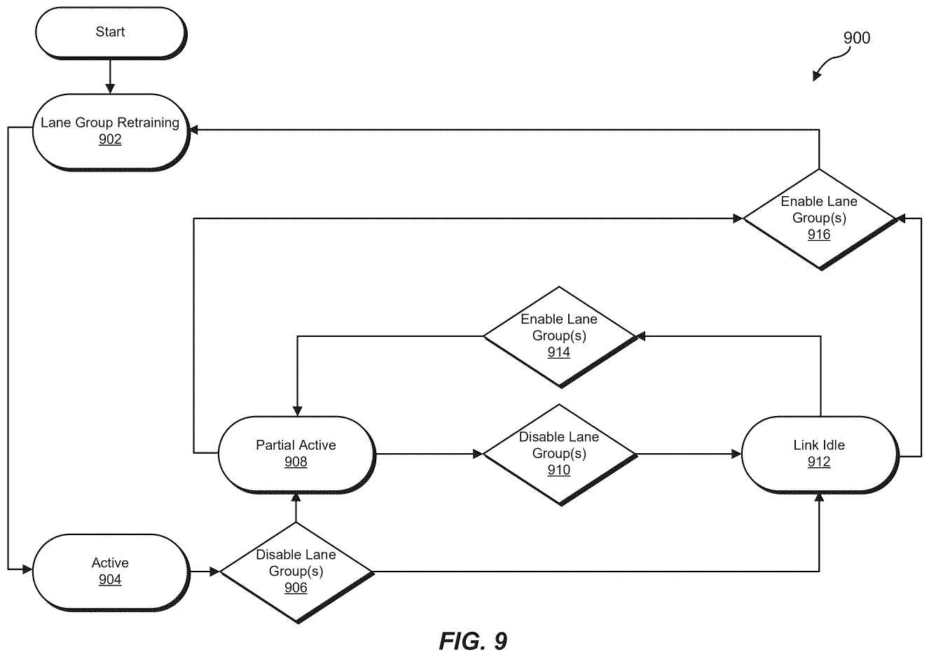

FIG. 9 shows a flow diagram 900 of an illustrative control method for operating a die-to-die link. One or more of the example systems described herein may operate a die-to-die link in accordance with the control method illustrated by flow diagram 900. As shown, method begins with the lane group retraining 902, which involves retraining the lane groups to ensure they are properly configured for data transmission. This step initializes the link and prepares the link for subsequent operations.

Retraining of lane groups involves a process where specific groups of lanes within a die-to-die link are reconfigured to ensure optimal data transmission. This process can be initiated in response to various conditions, such as detecting errors in one or more lanes, changes in data transfer requirements, or transitioning lanes from an idle state back to an active state. The retraining process typically includes recalibrating the physical parameters of the lanes, such as signal timing and voltage levels, to ensure reliable communication between the dies.

During retraining, the link controller can independently manage each lane group, allowing for selective retraining of only the affected lanes while maintaining data transmission across the other lanes. This independent control helps avoid the need for a complete link retraining, which would otherwise render the entire link temporarily unavailable for data transfer. By focusing retraining efforts on specific lane groups, the system can minimize disruptions and maintain higher overall link bandwidth.

The retraining process may involve several steps, including transmitting predefined bit patterns, such as continuous mode “VALTRAIN” or “LFSR” patterns, to recalibrate the lanes. These patterns help synchronize the transmitter and receiver, ensuring that data can be accurately transmitted and received. The link controller may also use control registers to manage the retraining process, setting values that indicate the current state of each lane group and coordinating the transition between idle and active states.

Retraining of lane groups is for maintaining the integrity and efficiency of die-to-die communication in environments where data transfer requirements can change dynamically. By enabling independent retraining of lane groups, the system can quickly adapt to new conditions, reduce power consumption, and avoid unnecessary interruptions in data transmission.

Once the lane groups are retrained, the method proceeds to the Active 904 state, where lane groups are active and transmitting data. This state represents the operational mode of the link, with lanes fully utilized for data transfer. If a decision is made to disable one or more lane groups, the method transitions to the disable lane group(s) 906 step. This step involves placing the specified lane groups into an electrical idle state, thereby reducing power consumption while maintaining data transmission across the remaining active lanes.

From the disable lane group(s) 906 step, the method can either return to the lane group retraining 902 step if further retraining is required, or the method can proceed to the partial active 908 state. In the partial active 908 state, only a subset of the lane groups are active, while the others remain in an idle state. This configuration allows for power savings while still maintaining some level of data transmission.

Within the partial active 908 state, the method includes decision points for enabling or disabling additional lane groups. The enable lane group(s) 914 step involves bringing additional lane groups out of the idle state and back into active operation, thereby increasing the link's data transfer capacity. Conversely, the disable lane group(s) 910 step involves placing additional lane groups into the idle state, further reducing power consumption.

If all lane groups are disabled, the method transitions to the link idle 912 state, where no data transmission occurs, and the link is in a low-power state. From the link idle 912 state, the method can proceed to the enable lane group(s) 916 step to bring lane groups back into active operation, or the method can return to the lane group retraining 902 step for reinitialization.

The illustrated method ensures that the link can dynamically adapt to changing data rate requirements and error conditions without necessitating a complete link retraining. By independently controlling the activity states of the lane groups, the method optimizes power management and maintains data transmission efficiency.

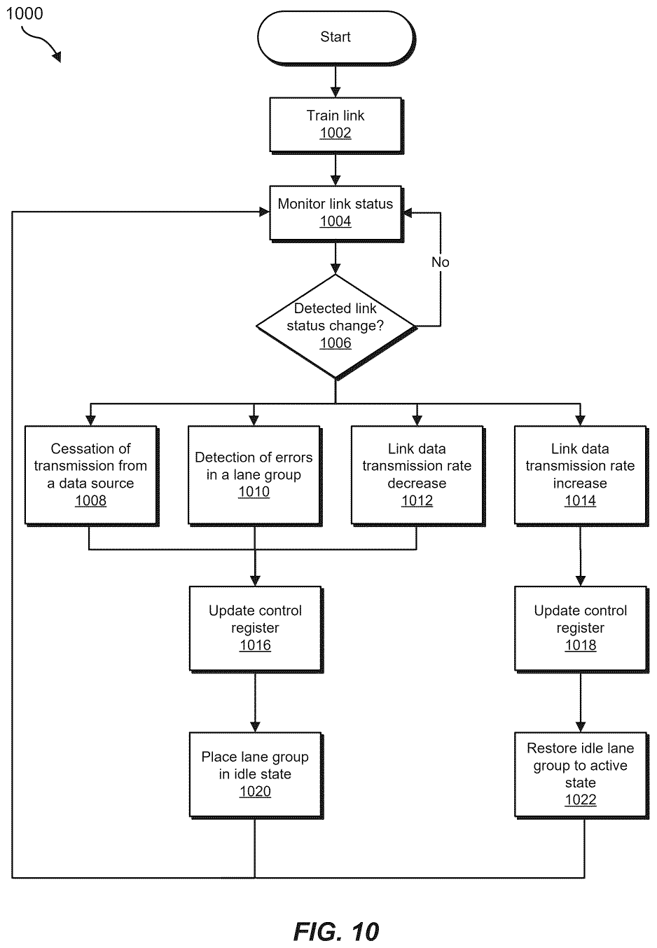

FIG. 10 shows a flow diagram 1000 of an additional illustrative control method for operating a die-to-die link. One or more of the example systems described herein may operate a die-to-die link in accordance with the control method illustrated by flow diagram 1000. The process begins with the start operation, which initiates the control method. The first step in the process is to train the link 1002. This step involves configuring the link to ensure proper data transmission between the dies. The training process may include calibrating the physical parameters of the lanes, such as signal timing and voltage levels, to ensure reliable communication.

Once the link is trained, the method proceeds to monitor the link status 1004. This step involves continuously checking the operational status of the link to detect any changes that may affect data transmission. The monitoring process ensures that the link can respond promptly to any detected status changes, maintaining the integrity and efficiency of data transmission between the dies.

The next step is to determine whether a link status change has been detected 1006. If no status change is detected, the method continues to monitor the link status 1004. If a status change is detected, the method proceeds to identify the specific type of status change.

There are at least four possible types of status changes that the method can detect:
1. Cessation of transmission from a data source 1008: This status change occurs when a data source stops transmitting data to the link. The method responds by updating the control register 1016 to reflect the change in the data source's activity. The method then places the corresponding lane group in an idle state 1020, conserving power while maintaining data transmission across the remaining active lanes.
2. Detection of errors in a lane group 1010: This status change occurs when errors are detected in one or more lanes of a lane group. The method responds by updating the control register 1016 to reflect the detected errors. The method then places the affected lane group in an idle state 1020, preventing the transmission of corrupted data while maintaining data transmission across the remaining active lanes.
3. Link data transmission rate decrease 1012: This status change occurs when the data transmission rate of the link decreases. The method responds by updating the control register 1018 to reflect the new data transmission rate. The method then restores the idle lane group to an active state 1022, increasing the link's data transfer capacity to accommodate the reduced data transmission rate.
4. Link data transmission rate increase 1014: This status change occurs when the data transmission rate of the link increases. The method responds by updating the control register 1018 to reflect the new data transmission rate. The method then restores the idle lane group to an active state 1022, increasing the link's data transfer capacity to accommodate the increased data transmission rate.

By independently controlling the activity states of the lane groups, the method optimizes power management and maintains data transmission efficiency. The method ensures that the link can dynamically adapt to changing data rate requirements and error conditions without necessitating a complete link retraining, thereby avoiding periods of zero link bandwidth and enhancing the overall efficiency and reliability of the die-to-die link.

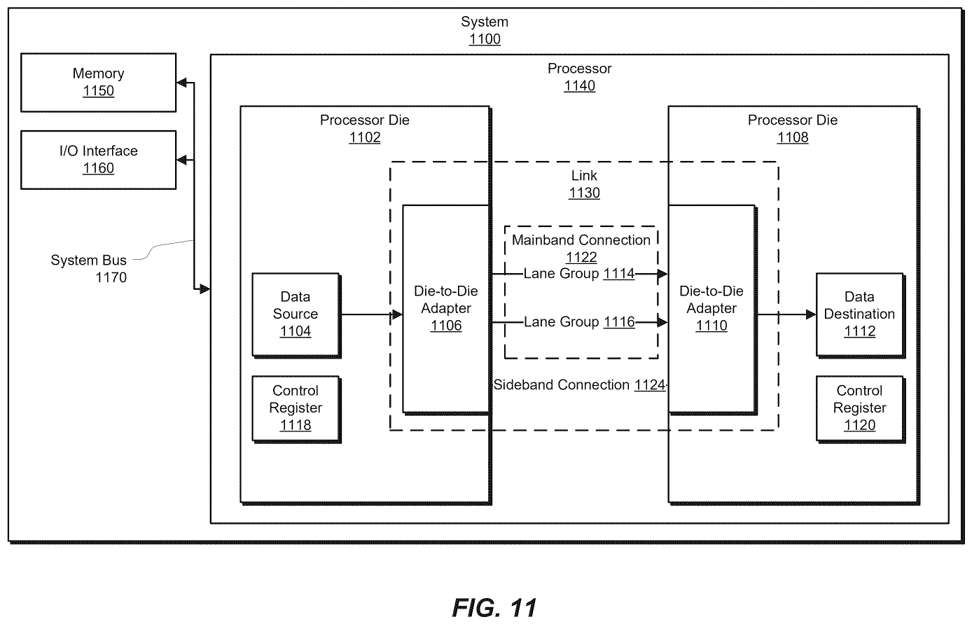

FIG. 11 illustrates a system-level die-to-die communication architecture. The architecture comprises a processor die 1102 and a processor die 1108 interconnected via a communication link 1130. A die adapter 1106 may serve as an intermediary between the processor die 1102 and the communication link 1130, facilitating communication and data transfer. Similarly, a die adapter 1110 may serve as an intermediary between the processor die 1108 and the communication link 1130.

In some cases, the processor die 1102 may include a data source 1104 connected to the die adapter 1106. The processor die 1108 may include a data destination 1112 connected to the die adapter 1110. The die adapter 1106 and the die adapter 1110 may coordinate data transfer between the data source 1104 and the data destination 1112 across the communication link 1130.

The communication link 1130 may include a lane group 1114 and a lane group 1116 for data transmission. A sideband connection 1124 may be used for control signaling between the die adapter 1106 and the die adapter 1110.

In some cases, a control register 1118 may be included in the processor die 1102 and may interface with the die adapter 1106. Similarly, a control register 1120 may be included in the processor die 1108 and may interface with the die adapter 1110. The control register 1118 and the control register 1120 may store configuration settings for the die adapter 1106 and the die adapter 1110 respectively.

Peripheral components may be integrated into the system. For example, a memory 1150 and an I/O interface 1160 may be connected to the processor die 1102 via a system bus 1170. The system bus 1170 may enable communication between the processor die 1102, the memory 1150, and the I/O interface 1160.

The elements included in the processor die 1102 may be comparable to the elements included in the system 100. For example, the processor die 1102 may include the data source 1104, the die adapter 1106, and the control register 1118, which may be similar to the data source 104, the die adapter 106, and the control register 118 in the system 100.

In some cases, the die adapter 1106 and the die adapter 1110 may interact to manage data transfer across the communication link 1130. The control register 1118 and the control register 1120 may be used to configure the die adapter 1106 and the die adapter 1110 respectively, enabling independent control of the lane group 1114 and the lane group 1116.

The memory 1150 and the I/O interface 1160 may interact with the processor die 1102 via the system bus 1170, providing storage and input/output capabilities to support the operations of the processor die 1102. This integration of peripheral components may enhance the overall functionality of the system-level die-to-die communication architecture.

In one embodiment, the system can be implemented in a high-performance computing environment where the die-to-die link is used to connect multiple processor dies within a server. In this scenario, the first lane group can be placed in an electrical idle state when the server is under low load conditions, thereby conserving power. The control register on the first die can be configured to dynamically adjust the activity state of the lane groups based on real-time monitoring of the server's workload. When the workload increases, the control register can trigger the retraining of the first lane group to bring the first lane group back to an active state, ensuring that the server can handle the increased data transfer requirements without significant latency.

In another embodiment, the system can be applied in a mobile device where power efficiency is crucial. Here, the first lane group can be placed in an electrical idle state during periods of low data transmission, such as when the device is in standby mode. The control register can be integrated into the device's power management unit, which monitors the device's activity and adjusts the lane groups' states accordingly. When the device transitions from standby to active use, the control register can quickly bring the first lane group back to an active state, ensuring seamless data transmission without draining the battery.

In a further embodiment, the system can be utilized in a data center environment where multiple virtual machines (VMs) share the same physical hardware. The first lane group can be placed in an electrical idle state when certain VMs are not actively transmitting data. The control register can be part of a virtualization management layer that monitors the data transmission needs of each VM and adjusts the lane groups' states to optimize power consumption. When a VM becomes active and requires data transmission, the control register can retrain the first lane group to bring the first lane group back to an active state, ensuring efficient use of the data center's resources.

In yet another embodiment, the system can be implemented in an automotive application where the die-to-die link connects various electronic control units (ECUs) within a vehicle. The first lane group can be placed in an electrical idle state when certain ECUs are not in use, such as when the vehicle is parked. The control register can be integrated into the vehicle's central control unit, which monitors the status of each ECU and adjusts the lane groups' states to conserve power. When the vehicle is started and the ECUs become active, the control register can quickly bring the first lane group back to an active state, ensuring reliable communication between the ECUs.

In an additional embodiment, the system can be applied in a consumer electronics device, such as a smart TV, where the die-to-die link connects the main processor to various peripheral components. The first lane group can be placed in an electrical idle state when the peripheral components are not in use, such as when the TV is displaying static content. The control register can be part of the TV's system-on-chip (SoC), which monitors the activity of the peripheral components and adjusts the lane groups' states to optimize power consumption. When the user interacts with the TV and the peripheral components become active, the control register can retrain the first lane group to bring the first lane group back to an active state, ensuring smooth operation of the TV.

As discussed throughout the instant disclosure, the devices, systems, and methods disclosed herein may provide one or more advantages over conventional interconnects. Embodiments of this disclosure may provide a mechanism to optimize power management in UCIe by enhancing the handling of stack multiplexing techniques, dynamic data rate changes, and error handling in standard packages. Embodiments may introduce a new ACTIVEp state, allowing each group of lanes in the mainband to go to electrical idle independently while other groups continue to carry data traffic. This may prevent redundant link retraining, reduce latencies for width degradation, and save significant power when two stacks are multiplexed over the same UCIe link. Additionally, embodiments may support dynamic data rate changes without the need for complete link retraining.

Embodiments of the present disclosure may address at least the following problems:
(1) Stack Multiplexing: When two protocol stacks are multiplexed over the same physical link, the bandwidth is halved for each protocol stack, and NOP flits are inserted when there is no traffic from a particular protocol stack, increasing power consumption. The present disclosure proposes using existing byte striping and placement logics to divide the lanes between the two protocols, allowing lanes with no traffic to go to electrical idle, thus saving power and avoiding the overhead of NOP flits.
(2) Dynamic Data Rate Requirement Change: Current UCIe specifications do not support dynamically changing data rate requirements without retraining the entire link, which increases power consumption and latency. The present disclosure proposes downsizing the link to a single active group when data rate requirements are low and upsizing it when requirements increase, without disturbing ongoing data transfers.
(3) Error Handling in Standard Package: When lane errors are confined to one group of lanes, the current UCIe specification requires complete link retraining, causing throughput losses and increased power consumption. The present disclosure proposes sending an ACTIVEp.reconfigure downsize request to put the group of lanes with errors into electrical idle, allowing data transfers to continue through the functional lanes without complete link retraining.

Some advantages of embodiments of the present disclosure may include preventing the link bandwidth from going to zero during data rate changes or lane errors, reducing latencies and power consumption involved in link retraining, and providing significant power savings by putting lanes into electrical idle based on dynamically changing data rate requirements. Embodiments may also avoid the overhead of NOP flit transfers and packet creation in two-protocol stack multiplexing over the same UCIe link.

Overall, embodiments of the present disclosure may enhance the efficiency and power management of UCIe links, making them more adaptable to changing data rate requirements and error conditions while maintaining data transmission efficiency and reducing power consumption.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising a die-to-die link adapter configured to:
detect a status change of a link between a first die and a second die, the link comprising at least a first lane group and a second lane group, the first die being configured to transmit data to the second die via the link; and
in response to detecting the status change of the link, modify one or more parameters of the first lane group while maintaining data transmission across the second lane group.

2. The device of claim 1, wherein the die-to-die link adapter is configured to modify the one or more parameters of the first lane group by placing the first lane group in an electrical idle state.

3. The device of claim 2, wherein:
the first die comprises a first control register and the second die comprises a second control register,
the first control register and the second control register are synchronized and specify at least an activity state of the first lane group and an activity state of the second lane group.

4. The device of claim 3, wherein the die-to-die link adapter is configured to place the first lane group in the electrical idle state by setting a control register value stored in the first control register to a value indicating that the first lane group is in the electrical idle state.

5. The device of claim 4, wherein the die-to-die link adapter is further configured to transmit, from the first die to the second die and in response to setting the control register value, signals indicating the control register value via a sideband communication channel between the first die and second die.

6. The device of claim 5, wherein the die-to-die link adapter is configured to receive, upon the second die receiving signals from the first die, an acknowledgement signal via the sideband communication channel after the second die synchronizes the second control register.

7. The device of claim 4, wherein the die-to-die link adapter is further configured to return the first lane group to an active state while maintaining data transmission across the second lane group, wherein returning the first lane group to the active state comprises retraining the first lane group.

8. The device of claim 7, wherein the die-to-die link adapter is configured to return the first lane group to the active state by setting the control register value to a value indicating that the first lane group is in the active state.

9. The device of claim 1, wherein the die-to-die link adapter is configured to detect the status change of the link by detecting one or more errors in one or more lanes of the first lane group, and to modify the one or more parameters of the first lane group by placing the first lane group in an electrical idle state.

10. The device of claim 1, wherein the die-to-die link adapter is configured to:
detect the status change of the link by determining that a data transfer rate from a data source on the first die to the link adapter or from the link adapter via the link satisfies a first data transfer rate criterion; and
modify the one or more parameters of the first lane group by placing the first lane group in an electrical idle state.

11. The device of claim 10, wherein the die-to-die link adapter is further configured to:
determine that the data transfer rate satisfies a second data transfer rate criterion, and
modify the one or more parameters of the first lane group to return the first lane group to an active state.

12. The device of claim 1, wherein the die-to-die link adapter is configured to spatially multiplex data transmission via the link, and wherein spatially multiplexing data transmission via the link includes transmitting first data provided by a first data source via the first lane group and transmitting second data provided by a second data source via the second lane group.

13. The device of claim 12, wherein the die-to-die link adapter is configured to detect the status change of the link by determining that the first data source has stopped transmitting data to the die-to-die link adapter of the first die.

14. The device of claim 1, wherein the die-to-die link adapter is configured to detect the status change of the link by detecting cessation of data transmission via the first lane group, and to modify the one or more parameters of the first lane group by placing the first lane group in an electrical idle state.

15. The device of claim 1, wherein the die-to-die link adapter is configured to maintain data transmission across the second lane group in accordance with a Universal Chiplet Interconnect Express (UCIe) protocol.

16. A system comprising:
a first die comprising a first die-to-die link adapter;
a second die comprising a second die-to-die link adapter; and
a link between the first die and the second die, the link comprising at least a first lane group and a second lane group,
wherein the first die-to-die link adapter is configured to:
transmit data to the second die-to-die link adapter via the link;
detect a status change of the link; and
in response to detecting the status change of the link, modifying one or more parameters of the first lane group while maintaining data transmission across the second lane group.

17. The system of claim 16, wherein detecting the status change comprises detecting one or more errors in lanes of the first lane group.

18. The system of claim 16, wherein detecting the status change of the link comprises detecting one or more errors in one or more lanes of the first lane group, and wherein modifying the one or more parameters of the first lane group comprises placing the first lane group in an electrical idle state.

19. The system of claim 16, wherein detecting the status change of the link comprises determining that a desired data transfer rate from a first data source over the link has decreased below a threshold amount, and wherein modifying the one or more parameters of the first lane group comprises placing the first lane group in an electrical idle state.

20. A method comprising:
detecting, by a die-to-die adapter, a status change of a link between a first die and a second die, the link comprising at least a first lane group and a second lane group, the first die being configured to transmit data to the second die via the link; and
in response to detecting the status change of the link, modifying, by the die-to-die adapter, one or more parameters of the first lane group while maintaining data transmission across the second lane group.
